(19) United States
(12) Patent Application Publication
(10) Pub. No.: US 2024/0284134 A1
(43) Pub. Date: Aug. 22, 2024

(54) Apparatus, Methods and Computer Programs for Obtaining Spatial Metadata

(71) Applicant: Nokia Technologies Oy, Espoo (FI)

(72) Inventors: Juha Tapio VILKAMO, Helsinki (FI); Mikko Johannes HONKALA, Espoo (FI)

(21) Appl. No.: 18/571,311

(22) PCT Filed: May 16, 2022
(86) PCT No.: PCT/FI2022/050325

§ 371 Date: Dec. 18, 2023

(30) Foreign Application Priority Data
Jun. 17, 2021 (GB) 2108642.6

(51) Int. Cl. H04S 7/00; G10L 19/008

(52) U.S. Cl. CPC H04S 7/302; G10L 19/008; H04S 2400/11; H04S 2400/15; H04S 2420/07

(57) ABSTRACT

Examples of the disclosure relate to obtaining spatial metadata for use in rendering, or otherwise processing spatial audio. In examples of the disclosure a machine learning model can be used to process microphone signals, or data obtained from microphone signals, to obtain the spatial metadata. The machine learning model can be trained to enable high quality spatial metadata to be obtained from sub-optimal or low-quality microphone arrays. Examples of the disclosure include an apparatus including circuitry for: accessing a trained machine learning model; determining input data for the machine learning model based on two or more microphone signals; enabling using the machine learning model to process the input data to obtain spatial metadata; and associating the obtained spatial metadata with at least one signal based on the two or more microphone signals to enable processing of the at least one signal based on the obtained spatial metadata.

### TECHNOLOGICAL FIELD

Examples of the disclosure relate to apparatus, methods and computer programs for obtaining spatial metadata. Some relate to apparatus, methods and computer programs for obtaining spatial metadata using machine learning models.

### BACKGROUND

Spatial audio enables spatial properties of a sound scene to be reproduced for a user so that the user can perceive the spatial properties. This can provide an immersive audio experience for a user or could be used for other applications. In order to enable the spatial properties to be reproduced spatial metadata is obtained and provided in a format that can be used to enable rendering of the spatial audio.

### BRIEF SUMMARY

According to various, but not necessarily all, examples of the disclosure there is provided an apparatus comprising means for:
accessing a trained machine learning model;
determining input data for the machine learning model based on two or more microphone signals;
enabling using the machine learning model to process the input data to obtain spatial metadata; and
associating the obtained spatial metadata with at least one signal based on the two or more microphone signals so as to enable processing of the at least one signal based on the obtained spatial metadata.

The processing may comprise rendering of spatial audio using the at least one signal based on the two or more microphone signals and the obtained spatial metadata.

Determining input data for the machine learning model may comprise obtaining cross correlation data, from the two or more microphone signals.

Determining input data for the machine learning model may comprise obtaining one or more of; delay data and frequency data corresponding to the cross correlation data.

The means may be for enabling transmission of the two or more microphone signals to one or more processing devices to enable the one or more processing devices to use the machine learning model to obtain the spatial metadata.

The means may be for enabling receiving the obtained spatial metadata from the processing device.

The spatial metadata may comprise information relating to one or more spatial properties of spatial sound environments corresponding to the two or more microphone signals wherein the information is configured to enable spatial rendering of the at least one signal based on the two or more microphone signals

The spatial metadata may comprise, for one or more frequency sub-bands, information indicative of;
a sound direction, and
sound directionality.

The machine learning model may be obtained from a system configured to train the machine learning model.

The means may before enabling the at least one signal based on the two or more microphone signals and the spatial metadata to be provided to another apparatus to enable rendering of the spatial audio.

The machine learning model may comprise a neural network.

According to various, but not necessarily all, examples of the disclosure there is provided an apparatus comprising an apparatus comprising at least one processor; and at least one memory including computer program code, the at least one memory and the computer program code configured to, with the at least one processor, cause the apparatus at least to perform:
accessing a trained machine learning model;
determining input data for the machine learning model based on two or more microphone signals;
enabling using the machine learning model to process the input data to obtain spatial metadata; and
associating the obtained spatial metadata with at least one signal based on the two or more microphone signals so as to enable processing of the at least one signal based on the obtained spatial metadata.

According to various, but not necessarily all, examples of the disclosure there is provided an electronic device comprising an apparatus as described herein wherein the electronic device comprises two or more microphones.

The electronic device may comprise at least one of: a smartphone, a camera, tablet computer, teleconferencing apparatus.

According to various, but not necessarily all, examples of the disclosure there is provided a method comprising:
accessing a trained machine learning model;
determining input data for the machine learning model based on two or more microphone signals;
enabling using the machine learning model to process the input data to obtain spatial metadata; and
associating the obtained spatial metadata with at least one signal based on the two or more microphone signals so as to enable processing of the of the at least one signal based on the obtained spatial metadata.

According to various, but not necessarily all, examples of the disclosure there is provided a computer program comprising computer program instructions that, when executed by processing circuitry, cause:
accessing a trained machine learning model;
determining input data for the machine learning model based on two or more microphone signals;
enabling using the machine learning model to process the input data to obtain spatial metadata; and
associating the obtained spatial metadata with at least one signal based on the two or more microphone signals so as to enable processing of the at least one signal based on the obtained spatial metadata.

### BRIEF DESCRIPTION

Some examples will now be described with reference to the accompanying drawings in which:

FIG. 1 shows an example apparatus;

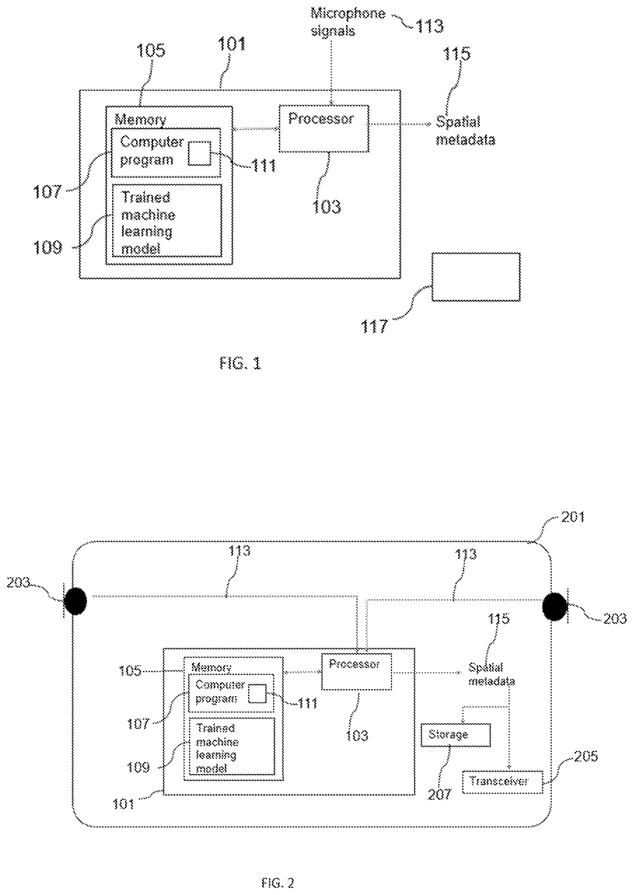

FIG. 2 shows an example device;

FIG. 3 shows an example method;

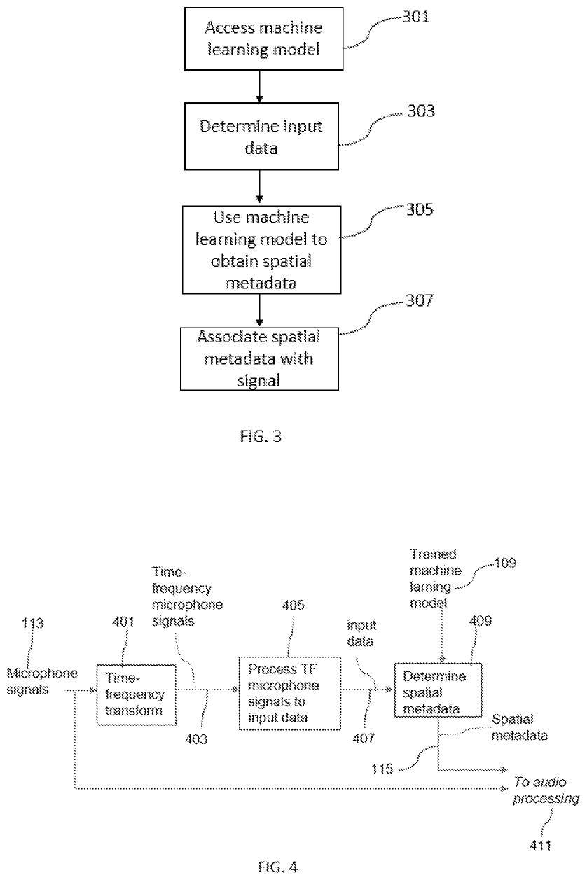

FIG. 4 shows an example method;

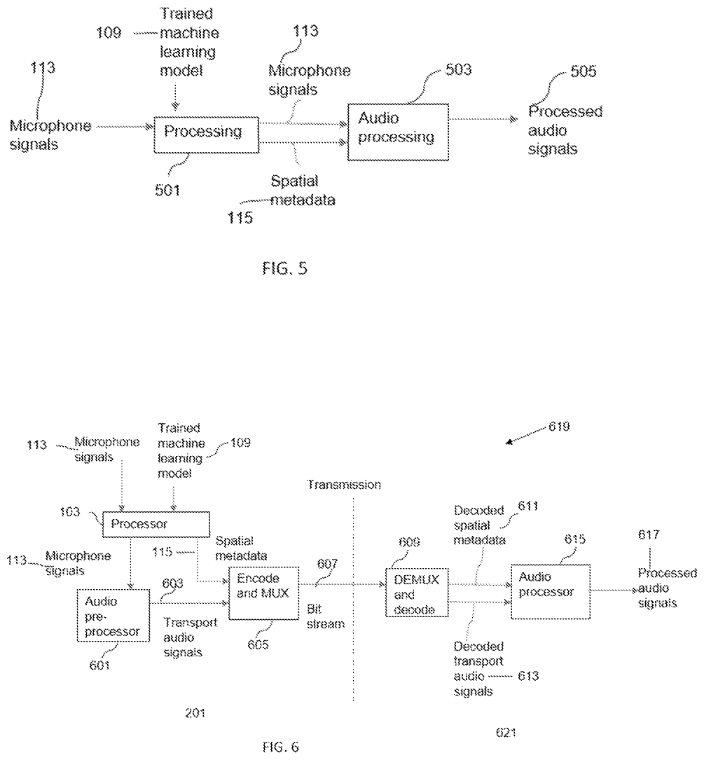

FIG. 5 shows an example method;

FIG. 6 shows an example system;

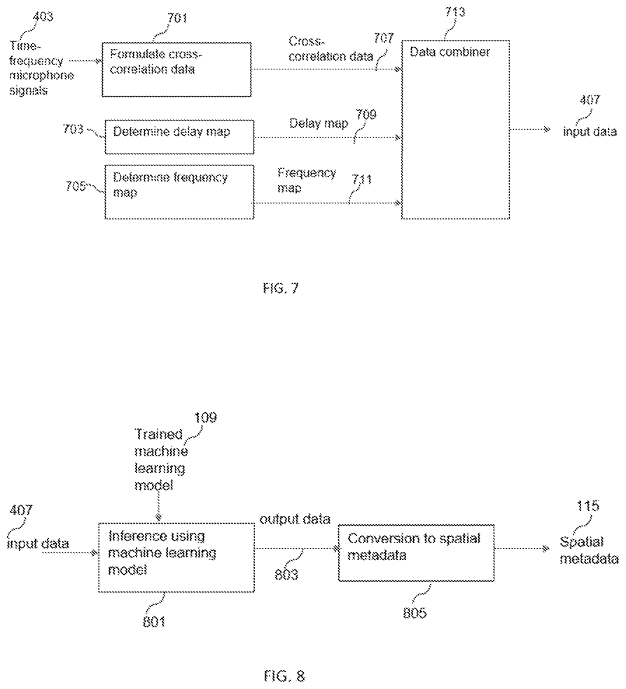

FIG. 7 shows an example method; and

FIG. 8 shows an example method.

### DETAILED DESCRIPTION

Examples of the disclosure relate to obtaining spatial metadata for use in rendering, or otherwise processing spatial audio. In examples of the disclosure a machine learning model can be used to process microphone signals, or data obtained from microphone signals, so as to obtain the spatial metadata. The machine learning model can be trained to enable high quality spatial metadata to be obtained even from sub-optimal or low-quality microphone arrays. Improving the quality of the spatial metadata that can be provided can also improve the quality of the spatial audio that is provided using the spatial metadata.

FIG. 1 shows an example apparatus 101 that could be used in some examples of the disclosure. In the example of FIG. 1 the apparatus 101 comprises at least one processor 103 and at least one memory 105. It is to be appreciated that the apparatus 101 could comprise additional components that are not shown in FIG. 1.

In the example of FIG. 1 the apparatus 101 comprises a processing apparatus. The apparatus 101 can be configured to use a machine learning model to process microphone signals to obtain spatial metadata.

In the example of FIG. 1 the implementation of the apparatus 101 can be implemented as processing circuitry. In some examples the apparatus 101 can be implemented in hardware alone, have certain aspects in software including firmware alone or can be a combination of hardware and software (including firmware).

As illustrated in FIG. 1 the apparatus 101 can be implemented using instructions that enable hardware functionality, for example, by using executable instructions of a computer program 107 in a general-purpose or special-purpose processor 103 that can be stored on a computer readable storage medium (disk, memory etc.) to be executed by such a processor 103.

The processor 103 is configured to read from and write to the memory 105. The processor 103 can also comprise an output interface via which data and/or commands are output by the processor 103 and an input interface via which data and/or commands are input to the processor 103.

The memory 105 is configured to store a computer program 107 comprising computer program instructions (computer program code 111) that controls the operation of the apparatus 101 when loaded into the processor 103. The computer program instructions, of the computer program 107, provide the logic and routines that enables the apparatus 101 to perform the methods illustrated in FIGS. 3 to 5 and 7 to 8. The processor 103 by reading the memory 105 is able to load and execute the computer program 107.

The memory 105 is also configured to store a trained machine learning model 109. The machine learning model could be a neural network or any other suitable type of machine learning model.

The trained machine learning model 109 can comprise a neural network or any other suitable type of trainable model. The term “Machine Learning Model” refers to any kind of artificial intelligence (AI), intelligent or other method that is trainable or tuneable using data. The machine learning model can comprise a computer program. The machine learning model can be trained to perform a task, such as estimating spatial metadata, without being explicitly programmed to perform that task. The machine learning model can be configured to learn from experience E with respect to some class of tasks T and performance measure P if its performance at tasks in T, as measured by P, improves with experience E. in these examples the machine learning model can often learn from reference data to make estimations on future data. The machine learning model can be also a trainable computer program. Other types of machine learning models could be used in other examples.

It is also possible to train one machine learning model with specific architecture, then derive another machine learning model from that using processes such as compilation, pruning, quantization or distillation. The term “Machine Learning Model” covers also all these use cases and the outputs of them. The machine learning model can be executed using any suitable apparatus, for example CPU, GPU, ASIC, FPGA, compute-in-memory, analog, or digital, or optical apparatus. It is also possible to execute the machine learning model in apparatus that combine features from any number of these, for instance digital-optical or analog-digital hybrids. In some examples the weights and required computations in these systems can be programmed to correspond to the machine learning model. In some examples the apparatus can be designed and manufactured so as to perform the task defined by the machine learning model so that the apparatus is configured to perform the task when it is manufactured without the apparatus being programmable as such.

The trained machine learning model 109 could be trained by a system that is separate to the apparatus 101. For example, the trained machine learning model 109 could be trained by a system or other apparatus that has a higher processing capacity than the apparatus 101 of FIG. 1. In some examples the machine learning model could be trained by a system comprising one or more graphical processing units (GPUs) or any other suitable type of processor.

The system that trains the machine learning model 109 is configured to use first capture data corresponding to the microphone array of a target device and second capture data corresponding to a higher quality or ideal reference microphone array, or any other suitable reference capture arrangement. The higher quality or ideal reference microphone array or reference capture arrangement could be a real or virtual array that provides ideal, or substantially ideal, reference spatial metadata. The machine learning model 109 is then trained to estimate the reference spatial metadata from the first capture data.

The trained machine learning model 109 could be provided to the memory 105 of the apparatus 101 via any suitable means. In some examples the trained machine learning model 109 could be installed in the apparatus 101 during manufacture of the apparatus 101. In some examples the trained machine learning model 109 could be installed in the apparatus 101 after the apparatus 101 has been manufactured. In such examples the machine learning model could be transmitted to the apparatus 101 via any suitable communication network.

The processor 103 is configured to receive microphone signals 113. The processor 103 can be configured to receive two or more microphone signals 113 from a microphone array. In some examples the microphone array can be comprised within the same device as the apparatus 101. In some examples the microphone array, or at least part of the microphone array, could be comprised within a device that is separate to the apparatus 101.

The microphone array can comprise any arrangement of microphones that can be configured to enable a spatial sound environment to be captured. In examples of the disclosure the microphone array that provides the microphone signals 113 can be a sub-optimal microphone array. There may be limitations on the quality of the spatial information that can be obtained by the microphone array that provides the microphone signals 113. This could be due to the positioning of the microphones, the number of the microphones, the type of microphones within the microphone array and/or any other relevant factors.

The processor 103 is configured to use the trained machine learning model 109 to process the microphone signals 113. In some examples the processor 103 can be configured to determine input data from the microphone signals 113 so that the input data can be used an input to the trained machine learning model 109. The processor 103 then uses the trained machine learning model 109 to process the input data to obtain spatial metadata 115.

The spatial metadata 115 that is provided by the trained machine learning model 109 can be used for rendering, or otherwise processing, spatial audio signals. The spatial metadata 115 comprises information relating to one or more spatial properties of spatial sound environments corresponding to the microphone signals 113. The information is configured to enable spatial rendering one or more signals based on the microphone signals.

The spatial metadata 115 that is output by the trained machine learning model 109 can be provided in any suitable format. In some examples the output of the machine learning model can be processed into a different format before it is used for rending spatial audio signals. For example, the output of the trained machine learning model 109 could be one or more vectors and these vectors could then be converted into a format that can be associated with the spatial audio signals for use in rendering, or otherwise processing, audio signals. For example, the vectors could be converted into a direction parameter and a directionality parameter for different frequency sub-bands.

The apparatus 101 therefore comprises: at least one processor 103; and at least one memory 105 including computer program code 111, the at least one memory 105 and the computer program code 111 configured to, with the at least one processor 103, cause the apparatus 101 at least to perform:
accessing a trained machine learning model;
determining input data for the machine learning model based on two or more microphone signals;
enabling using the machine learning model to process the input data to obtain spatial metadata; and
associating the obtained spatial metadata with at least one signal based on the two or more microphone signals so as to enable processing of the at least one signal based on the obtained spatial metadata.

As illustrated in FIG. 1 the computer program 107 can arrive at the apparatus 101 via any suitable delivery mechanism 117. The delivery mechanism 117 can be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 107. The delivery mechanism can be a signal configured to reliably transfer the computer program 107. The apparatus 101 can propagate or transmit the computer program 107 as a computer data signal. In some examples the computer program 107 can be transmitted to the apparatus 101 using a wireless protocol such as Bluetooth, Bluetooth Low Energy, Bluetooth Smart, 6LoWPan (IPᵥ6 over low power personal area networks) ZigBee, ANT+, near field communication (NFC), Radio frequency identification, wireless local area network (wireless LAN) or any other suitable protocol.

The computer program 107 comprises computer program instructions for causing an apparatus 107 to perform at least the following:
accessing a trained machine learning model;
determining input data for the machine learning model based on two or more microphone signals;
enabling using the machine learning model to process the input data to obtain spatial metadata; and
associating the obtained spatial metadata with at least one signal based on the two or more microphone signals so as to enable processing of the at least one signal based on the obtained spatial metadata.

The computer program instructions can be comprised in a computer program 107, a non-transitory computer readable medium, a computer program product, a machine readable medium. In some but not necessarily all examples, the computer program instructions can be distributed over more than one computer program 107.

Although the memory 105 is illustrated as a single component/circuitry it can be implemented as one or more separate components/circuitry some or all of which can be integrated/removable and/or can provide permanent/semi-permanent/dynamic/cached storage.

Although the processor 103 is illustrated as a single component/circuitry it can be implemented as one or more separate components/circuitry some or all of which can be integrated/removable. The processor 103 can be a single core or multi-core processor.

References to “computer-readable storage medium”, “computer program product”, “tangibly embodied computer program” etc. or a “controller”, “computer”, “processor” etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term “circuitry” can refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions and
(c) hardware circuit(s) and or processor(s), such as a microprocessor(s) or a portion of a microprocessor(s), that requires software (e.g. firmware) for operation, but the software might not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the FIGS. 3 to 5 and 7 to 8 can represent steps in a method and/or sections of code in the computer program 107. The illustration of a particular order to the blocks does not necessarily imply that there is a required or preferred order for the blocks and the order and arrangement of the block can be varied. Furthermore, it can be possible for some blocks to be omitted.

FIG. 2 shows an example device 201. The device 201 comprises an apparatus 101 as shown in FIG. 1 and described above. The device 201 could be a user device such as a mobile telephone, a camera, a tablet computer, a teleconferencing apparatus or any other suitable device that could be used for capturing spatial audio.

In the example of FIG. 2 the device 201 comprises two microphones 203, a transceiver 205 and storage 207. It is to be appreciated that the device 201 could also comprise additional components that are not shown in FIG. 2.

The microphones 203 can comprise any means that can be configured to convert an incident acoustic signal to output an electric microphone signal 113. The output microphone signal 113 can be provided to the processor 103 for processing. The processing that is performed by the processor 103 can comprise converting the microphone signal 113 into input data that can be used by the trained machine learning model 109.

The microphones 203 can comprise a microphone array. In the example of FIG. 2 the device 201 comprises two microphones 203. Other numbers of microphones 203 could be provided within the microphone array in other examples of the disclosure. In the example of FIG. 2 the microphones 203 are provided on opposite edges of the device 201. A first microphone 203 is provided at a left edge of the device 201 and a second microphone 203 is provided at a right edge of the device 201. Other numbers and arrangements of the microphones 203 could be used in other examples of the disclosure.

The microphones 203 of the device 201 can be configured to capture the sound environment around the device 201. The sound environment can comprise sounds from sound sources, reverberation, background ambience, and any other type of sounds.

The microphones 201 can be configured to provide microphone signals 113 in any suitable format. In some examples the microphone signals 113 could be provided in pulse code modulation (PCM) format. In other examples the microphone signals 113 can comprise analogue signals. In such cases an analogue-to-digital converter can be provided between the microphones 201 and the processor 103.

The processor 103 can be configured to use the trained machine learning model 109 to process the input data obtained from the microphone signals 113. The trained machine learning model 109 is configured to provide spatial metadata 115 as an output. In some examples processing of the input data can comprise intermediate stages which can be optional. In some embodiments the trained machine learning model 109 can be configured to provide an intermediate output data that is further processed to obtain the spatial metadata 115.

In some examples the spatial metadata 115 that is obtained by the machine learning model 109 can be associated with at least one signal based on the microphone signals 113 provided by the microphones 203. The signal based on the microphone signals 113 can comprise an audio signal, such as a spatial audio signal, or any other suitable type of signal. The signal based on the microphone signals could comprise any signal that comprises data originating from the microphone signals 113. In some examples the microphone signals 113 can be processed into a different format to provide the at least one signal. In other examples the microphone signals 113 could be used as the signal without any, or substantially without any, processing to the microphone signals 113.

The spatial metadata 115 can be associated with the signal so as to enable processing of the at least one signal based on the obtained spatial metadata 115. For example, the processing could comprise rendering of spatial audio using an audio signal and the obtained spatial metadata 115 or any other suitable processing. The spatial metadata 115 can be associated with the audio signal so that the spatial metadata 115 can be transmitted with the audio signal and/or the spatial metadata 115 can be stored in the storage 207 with the audio signal.

The processor 103 can be configured to associate the spatial metadata 115 with a corresponding audio signal. the audio signal can be based on the microphone signals 113. The output of the processor 103 can therefore comprise the spatial metadata 115 and the associated audio signal. The output can be provided in any suitable form such as PCM (pulse code modulation), or in an encoded format. The encoded format could be AAC (advanced audio coding) such as mono, stereo, binaural, multi-channel, or Ambisonics.

In some configurations the output could simply be a mono signal. This could be the case in examples where the spatial metadata 115 is used to spatially suppress one or more directions of the spatial sound environment.

The device 201 shown in FIG. 2 comprises a transceiver 205 and storage 207. The processor 103 is coupled to the transceiver 205 and/or the storage 207 so that the spatial metadata 115 and/or the associated signal can be provided to a transceiver 205 and/or to storage 207.

The transceiver 205 can comprise any means that can enable data to be transmitted from the device 201. This can enable the spatial metadata 115 to be transmitted from the device 201 to an audio rendering device or any other suitable device.

The storage 207 can comprise any means for storing the spatial metadata 115. The storage 207 could comprise one or more memories or any other suitable means.

In some examples additional data can be associated with the spatial metadata 115 and/or the audio signal. For instance, in some examples the device 201 could comprise one or more cameras and could be configured to capture images to accompany the audio. In such examples data relating to the images can be associated with the audio signals and the spatial metadata 115. This can enable the data relating to the images to be transmitted and/or stored with the audio signals and the spatial metadata 115.

FIG. 3 shows an example method that could be performed using an apparatus 101 and/or device 201 as shown in FIGS. 1 and 2.

The method comprises, at block 301 accessing a trained machine learning model 109. In some examples the trained machine learning model 109 can be stored in the memory 105 of the device 201 that captures the microphone signal 113. In such examples the trained machine learning model 109 can be accessed by accessing the memory of the device 201. In other examples the trained machine learning model 109 could be stored externally of the device 201. For instance, it could be stored within a network or at a server or in any other suitable location. In such examples the accessing of the trained machine learning model 109 comprises accessing the trained machine learning model 109 in the external location.

The trained machine learning model 109 can be trained by a separate system that is configured to train the machine learning model 109. The trained machine learning model 109 can then be obtained by the apparatus 101 or device 201 for use in capturing spatial audio.

At block 303 the method comprises determining input data for the machine learning model 109. The input data is determined based on two or more microphone signals 203. The two or more microphone signals 113 can be obtained from a microphone array that is configured to capture spatial audio. The microphone array could be a sub-optimal microphone array. There may be limitations on the quality of the spatial information that can be obtained by the microphone array. For instance, the microphone array could comprise a small number of microphones 203, such as two microphones. In some examples the position of the microphones 203 within the microphone array and/or the types of microphones within the array can limit the accuracy of the spatial information within the microphone signals 113. The microphone array can comprise one or more microphones that are positioned further away from other microphones and/or provided in another device to other microphones within the array.

Determining the input data can comprise any processing of the microphone signals 113 that converts the microphone signals 113, or information comprised within the microphone signals 113, into a format that can be used by the machine learning model 109. In some examples determining input data for the machine learning model 109 comprises obtaining cross correlation data, delay data and frequency data from the two or more microphone signals 113. In some examples determining input data for the machine learning model 109 comprises obtaining delay data and/or frequency data corresponding to the microphone signals 113. Other processes for determining the input data for the machine learning model 109 could be used in other examples of the disclosure.

At block 305 the method comprises enabling using the machine learning model 109 to process the input data to obtain spatial metadata 115. The machine learning model 109 could be a neural network or any other suitable type of machine learning model.

The spatial metadata 115 comprises information relating to one or more spatial properties of spatial sound environments corresponding to the two or more microphone signals 113. The spatial metadata 115 can comprise information indicative of spatial properties of sound distributions that are captured by the microphones 201. The information indicative of the spatial properties enables spatial rendering of signals based on the microphone signals 113. The signals based on the microphone signals 113 could comprise audio signals or any other suitable type of signal.

The spatial metadata 115 that is output by the machine learning model 109 can be provided in any suitable format. In some examples the output of the machine learning model 109 can be processed into a different format before it is used for rending spatial audio signals. For example, the output of the machine learning model 109 could be one or more vectors and these vectors could then be converted into a format that can be associated with the spatial audio signals for use in rendering, or otherwise processing of, the audio signals. For example, the vectors could be converted into a direction parameter and a directionality parameter for different frequency sub-bands.

In some examples the spatial metadata 115 can comprise, for one or more frequency sub-bands, information indicative of a sound direction and sound directionality. The sound directionality can be an indication of how directional or non-directional the sound is. The sound directionality can provide an indication of whether the sound is ambient sound or provided from point sources. The sound directionality can be provided as energy ratios of sounds from different directions or in any other suitable format.

The trained machine learning model 109 can be trained so as to estimate high quality spatial metadata as an output. The trained machine learning model 109 can be trained to estimate the spatial metadata that would be obtained by an ideal or high-quality reference microphone array, or any other suitable reference capture method. In some examples the machine learning model could have been trained using a virtual ideal microphone array or any other suitable process.

The spatial metadata 115 that is provided as an output of the trained machine learning model 109 is therefore of a higher quality than would ordinarily be obtained from the microphone signals 113 of the microphone array. The spatial metadata 115 could comprise spatial information estimating the spatial information captured using an ideal reference microphone array or any other reference capture method but not captured using the actual microphone array that provided the microphone signals 113.

At block 307 the method comprises associating the obtained spatial metadata 115 with at least one signal. The at least one signal is based on the two or more microphone signals. The at least one signal could be an audio signal. In some examples the at least one signal could be the microphone signals. In some examples the at least one signal could comprise processed microphone signals. The association of the spatial metadata 115 with the at least one signal enables processing of the at least one signal based on the obtained spatial metadata. For example, it can enable spatial rendering of the at least one signal using information comprised within the spatial metadata.

The spatial metadata 115 and the corresponding audio signals can be provided in any suitable format. For example, the output could be provided as an audio signal and spatial metadata configured to enable spatial sound rendering. In some examples the spatial metadata could be provided in an encoded form such as an IVAS (immersive Voice and Audio Stream) stream.

In some examples the output could comprise a binaural audio signal where the binaural audio signal is generated based on the determined spatial metadata 115 and the microphone signals 113. In some examples the output could comprise a surround loudspeaker signal where the surround loudspeaker is generated based on the determined spatial metadata 115 and the microphone signals 113. In some examples the output could comprise Ambisonic audio signals where the Ambisonic audio signals are generated based on the determined spatial metadata 115 and the microphone signals 113. Other formats could be used in other examples. The audio signals could comprise one channel or a plurality of channels.

It is to be appreciated that the blocks shown in FIG. 3 could be performed in any suitable order and need not be performed in the order as shown. For example, blocks 301, and 303 could be performed in any order or could be performed simultaneously.

It is also to be appreciated that, in some examples, the method could comprise additional blocks that are not shown in FIG. 3. For instance, in some examples the method could comprise enabling transmission of the two or more microphone signals 113 to one or more processing devices. This could enable the one or more processing devices to use the machine learning model 109 to obtain the spatial metadata 115. This could be used if the machine learning model 109 is not stored within the device 201 that comprises the microphone array.

For instance, this could be used in examples where the machine learning model 109 is stored in one or more separate devices that can be accessed by the device 201. In such examples the method could also comprise receiving the obtained spatial metadata 115 from the remote processing device. The apparatus 101 could then associated the received spatial metadata 115 with the microphone signals 113 or a signal based on the microphone signals 113.

FIG. 4 shows an example method that could be implemented using examples of the disclosure. The method could be implemented using an apparatus 101 as shown in FIG. 1 and/or a device 201 as shown in FIG. 2 and/or any other suitable type of device.

At bock 401 the microphone signals 113 are transformed into the time-frequency domain. This converts the microphone signal 113 into time-frequency microphone signals 403. Any suitable process can be used to transform the microphone signals 113 into the time-frequency domain.

The microphone signals 113 can comprise any two or more microphone signals from a microphone array that captures spatial audio.

At block 205 the time-frequency microphone signals 403 are processed so as to obtain input data 407 for the machine learning model 109. The processing can comprise any process that converts the data from the time-frequency microphone signals 403 into a format that is suitable for use as an input for the machine learning model 109.

In some examples the processing that obtains the input data 407 can comprise obtaining cross correlation data, delay data and frequency data from the time-frequency microphone signals 403. In some examples the processing that obtains the input data 407 can comprise obtaining delay data and/or frequency data corresponding to the time-frequency microphone signals 403. Other processes could be used in other examples of the disclosure.

At block 409 the trained machine learning model 109 is accessed and used to determine the spatial metadata 409. The input data 407 is provided as an input to the trained machine learning model 109 and spatial metadata 115 is provided as an output.

The machine learning model 109 is trained to provide high quality spatial metadata 115 as an output. The high-quality spatial metadata 115 could comprise spatial metadata that could be an estimate of the spatial metadata that would be obtained using a reference microphone array or a substantially ideal reference microphone array or any other suitable reference capture method rather than the microphone array that has been used to obtain the microphone signal 113.

At block 411 the spatial metadata 115 is associated with the microphone signals 113 and is provided for audio processing. For example, the spatial metadata 115 can be used for rendering spatial audio signals based on the microphone signals 113. As the spatial metadata 115 is of a high quality this can enable rendering of high-quality spatial audio even though a limited microphone array has been used to capture the spatial sound environments.

The audio processing device can comprise any suitable audio processing device. In some examples the same device 201 that captures the microphone signals 113 could also be used for the audio processing. In other examples the audio processing device could be a separate device. In such examples the spatial metadata 115 can be associated with the microphone signals 113 and transmitted to the another device and/or to storage in another location.

FIG. 5 shows an example method that could be implemented in examples of the disclosure. The method could be implemented using an apparatus 101 as shown in FIG. 1 and/or a device 201 as shown in FIG. 2 and/or any other suitable type of device.

At bock 501 the microphone signals 113 are processed using the trained machine learning model 109. The processing at block 501 provides spatial metadata 115 and the microphone signals 113 as an output. In this example the microphone signals 113 are passed through by the processor 103. In other examples the processor 103 could perform one or more operations on the microphone signals 113.

The spatial metadata 115 and the microphone signals 113 are used for audio processing at block 503. The audio processing comprises audio rendering to provide processed audio signals 505. The processed audio signals 505 could comprise binaural audio signals or any other suitable type of audio signals. The processed audio signals 505 could be provided to a playback device for play back to a user. For example, binaural signals could be played back using headphones. The processed audio signals 505 can be stored and/or transmitted as appropriate.

Any suitable processing can be used at block 503. The processing that is used can be dependent upon the type of spatial audio capturing or any other suitable factor. For example in parametric spatial audio capturing, the audio processing could comprise obtaining the microphone signal 113 and the spatial metadata 115 and processing the microphone signals 113 based on the spatial metadata 115 to obtain a processed audio signal 505 comprising spatial audio.

In cases where the processed audio signals 505 is to comprise a binaural signal the audio processing could be performed by a binaural renderer. The binaural renderer could perform a process comprising:
Converting the microphone signals 113 to time-frequency signals. The conversion could be performed using a STFT (Short-time Fourier transform) or any other suitable means.
In frequency bands, using multipliers \sqrt{ratio(k)} and \sqrt{1-ratio(k)} to divide the microphone signals 113 into direct and ambient components.
Using head-related transfer functions to steer the directional part of the audio signal to the direction determined by azi(k). To enable this a user's head orientation can be tracked and the direction value can be modified accordingly.
Using decorrelators to generate a suitable binaural diffuse cross-correlation for the ambient part.
Combining the processed direct and ambient part signals
Returning the result to the time domain signals using an inverse filter bank. In this case, an inverse STFT could be used.

A similar process could be used in cases where the processed audio signals 505 are to be used for a surround sound loudspeaker system. In such cases amplitude panning functions would be used instead of head related transfer functions. In such cases the ambience part would be decorrelated to all channels incoherently.

A similar process could also be used in cases where the processed audio signals 505 are to be used for Ambisonics. In such cases Ambisonic panning functions would be used instead of head related transfer functions. In such cases the ambience part would be decorrelated to all channels incoherently, with suitable levels according to the selected Ambisonic normalization scheme.

Other methods for performing the audio processing could be used in other examples of the disclosure. For instance, in some examples the audio signals might not be divided into intermediate directional and ambient parts. Instead both the directional and ambient parts could be rendered at the same time. This reduces the need for decorrelation of the audio signal.

It is also to be appreciated that other processes can be performed on the microphone signals 113 in addition to the spatialisation. Such processes could comprise equalization, automatic gain control, limiter, noise reduction, wind noise reduction, audio focus, and/or any other suitable process.

Once the processed audio signals 505 have been obtained the processed audio signals 505 can be encoded. The processed audio signals 505 can be encoded using any suitable encoding scheme, for example AAC.

In some examples the processed audio signals 505 need not comprise the spatial metadata 115 because the processed audio signals 505 can be in a form that can be reproduced without spatial metadata 115. However, in other embodiments the processed audio signals 505 could also comprise spatial metadata 115. This could be used for examples where the rendering device could be a legacy device that could use the spatial metadata to reproduce a spatial audio signal. This could also be used for improved rendering devices which could use the spatial metadata 115 to perform further processing of the processed audio signals 505. This could allow the processed audio signals 505 to be converted into a different format for example.

FIG. 6 shows an example system 619 that could be used to implement examples of the disclosure. The system 619 comprises a capturing device 201 and a playback device 621. The capturing device 201 could be a device as shown in FIG. 2 or any other suitable type of device. The playback device 621 could comprise any device that is configured to receive a bit stream comprising the audio signal and enable rendering and playback of the spatial audio. The playback device 621 could be, for example, a head set, another user device such as a mobile phone, or any other suitable type of device.

In the example of FIG. 2 the capturing device 201 comprises a processor 103, an audio pre-processor 601 and an encoding and multiplexing module 605.

The processor 103 can be as shown in FIG. 2 and as described above. The processor 103 is configured to receive a plurality of microphone signals 113 from a microphone array associated with the capture device 201. The processor 103 is also configured to receive the trained machine learning model 109. For example, the trained machine learning model 109 could be accessed from the memory 105 of the capture device 201 or from any other suitable location.

The processor 103 obtains input data from the microphone signals 113 and uses the trained machine learning model 109 to process the input data to obtain spatial metadata 115. This provides spatial metadata 115 as an output.

The audio pre-processor 601 is configured to receive the microphone signals 113 as an input. The audio pre-processor 601 is configured to process the microphone signals 113. The audio pre-processor 601 can comprise any suitable means for processing microphone signals 113. In some examples the audio pre-processor 601 can be configured to apply automatic gain control, limiter, wind noise reduction, spatial noise reduction, spatial filtering, or any other suitable audio processing. In some examples the audio pre-processor 601 can also be configured to reduce the number of channels within the microphone signals 113. For example, the audio pre-processor 601 can be configured to generate a stereo output signal even if there were more than two microphone signals 113.

The audio pre-processor 601 provides transport audio signals 603 as an output.

The encoding and multiplexing module 605 is configured to receive the spatial metadata 115 and the transport audio signals 603. The encoding and multiplexing module 605 is configured to encode the spatial metadata 115 and the transport audio signals 603 into any suitable format. The encoding and multiplexing module 605 comprises means for encoding the spatial metadata 115 and the transport audio signals 603 into any suitable format.

In some examples, the transport audio signals 603 could be encoded with an AAC encoder or EVS (enhanced voice service) encoder or any other suitable type of encoder. The spatial metadata 115 could be quantized to a limited set of values or encoded in any other suitable way.

The encoding and multiplexing module 605 then multiplexes the encoded transport audio signals 603 and the encoded spatial metadata 115 to provide a bit stream 607 as an output.

The bit stream 607 can be transmitted from the capture device 201 to the playback device 621 using any suitable means.

The playback device 621 comprises a demultiplexing and decoding module 609 and an audio processor 615.

The demultiplexing and decoding module 609 receives the bitstream 607 as an input. The demultiplexing and decoding module 609 is configured to demultiplex and decode the bitstream 607. The demultiplexing and decoding module 609 can comprise means for demultiplexing and decoding the bit stream 607. The processes used to demultiplex and decode the bitstream 607 are corresponding processes to those used by the encoding and multiplexing module 605 of the capture device 201.

The demultiplexing and decoding module 609 provides decoded spatial metadata 611 and decoded transport audio signals 613 as an output. The audio processor 615 receives the decoded spatial metadata 611 and decoded transport audio signals 613 and uses them to provide the processed audio signals 617. Any suitable processes can be used to generate the processed audio signals 617.

FIG. 7 shows an example method that can be used to obtain input data 407 for the machine learning model 109 in examples of the disclosure. The example method of FIG. 7 could be performed by the apparatus 101 of FIG. 1 or FIG. 2 or by any other suitable means.

The method of FIG. 7 can be used to generate the input data in a format that corresponds to the format used for training of the machine learning model 109.

In this following example it is assumed that machine learning model 109 is a neural network and that the microphone array that is used to capture the microphone signals 113 only comprises two microphones 203. It is to be appreciated that in other examples the microphone array could comprise more than two microphones 203 and that other types and structures of machine learning models 109 could be used in other examples of the disclosure.

The method receives time-frequency microphone signals 403 as an input. The time-frequency microphone signals 403 can be as shown in FIG. 4 or can be in any other suitable format. Any suitable process can be used to transform the microphone signals 113 into the time-frequency microphone signals 403. For example, the transforming could be performed using a complex-modulated quadrature mirror filter (QMF) bank, or any other suitable types of filter.

In this example the transform is performed using a short-time Fourier transform with a frame size of 1024 samples. This process comprises using a square-root-Hann window over a 2048 sample sequence (with the current and the precious frame cascaded) and applying FFT (fast Fourier transform) to the result. This process results in 1025 unique frequency bins representation for each frame and microphone channel, denoted s(b,i), where b=1, . . . , 1025 is the bin index and i is the microphone channel index. In this example the time dependency of the signal has been omitted for brevity of notation.

At block 701 the time-frequency microphone signals 403 s(b,i) are received as an input and cross-correlation data 707 is formulated from the time-frequency microphone signals 403 s(b,i). In this example two microphones 203 i=1, 2 are used to capture the microphone signals 113 so the inter-correlation data can be formulated for the two microphones 201.

In some examples the cross-correlation data 707 can comprise normalized correlation data c(d,l) that is formulated using

$$c ( d , l ) = \frac{Real \{ {\sum }_{b = {b}_{low} ( l )}^{{b}_{high} ( l )} s ( b , 1 ) {s}^{*} ( b , 2 ) {e}^{j 2 π * freq ( b ) * dly ( d )} \}}{\sqrt{( {\sum }_{b = {b}_{low} ( l )}^{{b}_{high} ( l )} {\vert s ( b , 1 ) \vert}^{2} ) ( {\sum }_{b = {b}_{low} ( l )}^{{b}_{high} ( l )} {\vert s ( b , 2 ) \vert}^{2} )}}$$

Where Real{ } denotes an operation preserving only the real part, d=1, . . . , 64 is a delay index, 1=1, . . . , 48 is a frequency index, b_{low}(l) and b_{high}(l) are bin limits for frequency index 1, freq(b) is the center frequency of bin b, dly(d) is the delay value corresponding to the delay index d, and j is the imaginary unit. The set of delay-values dly(d) can be determined so that they span a reasonable range given the spacing of the microphones 203. For example, if the device 201 used to capture the microphone signal is a smartphone in a landscape mode, then the delays could be spaced evenly in the range between −0.7 and 0.7 milliseconds. Other delays could be used in other examples of the disclosure.

In this example, the bin limits b_{low}(l) and b_{high}(l) approximate the frequency resolution of the Bark bands so that two consecutive frequency indices together form one Bark band. Therefore, the number of these bands l is 48.

The output of the formulate cross-correlation data block 701 is therefore the normalized correlation data c(d,l).

At block 703 a delay map 709 is determined. The delay map 709 is configured to associate positions (d,l) within a data array to certain normalized delays. This aids the operation of the machine learning model 109. The delay map 709 comprises delay values

$${m}_{d} ( d , l ) = norm ( dly ( d ) )$$

where norm( ) is a function that normalizes an image channel mean to zero and standard deviation to 1. The delay map therefore has a size 64×48. This is the same size as the correlation data 709 c(d,l).

The delay map 709 does not vary and so it can be determined only once and used a plurality of times.

The output of the determine delay map block 703 is therefore the delay map 709 m_{d}(d,l).

At block 705 a frequency map 711 is determined. The frequency map 711 is configured to associate positions (d,l) within a data array to certain frequency bands. This aids the operation of the machine learning model 109. The frequency map 711 comprises frequency reference values so that

$${m}_{l} ( d , l ) = norm ( floor ( \frac{l}{2} ) )$$

where floor( ) function rounds to the previous integer value. The frequency reference values therefore relate the 48 frequency indices to the 24 Bark bands. The 24 Bark bands are the bands in which the spatial metadata 115 is estimated.

The frequency map 711 does not vary and so it can be determined only once and used a plurality of times.

The output of the determine frequency map block 705 is therefore the frequency map 711 mₗ(d,l).

At block 713 a data combiner receives the cross-correlation data 707 c(d,l), the delay map 709 m_{d}(d,l) and the frequency map 711 mₗ(d,l). The data combiner generates input data 401 comprising a data set m(d,l,c) of a suitable size for use by the machine learning model 109 where c=1, 2, 3 is the channel index. In this example the data combiner generates a 64×48×3 size data-set m(d,l,c)

The data combiner is configured to associate the input data sets by

$$m ( d , l , 1 ) = c ( d , l ) \\ m ( d , l , 2 ) = {m}_{d} ( d , l ) \\ m ( d , l , 3 ) = {m}_{l} ( d , l )$$

So as to provide the data-set m(d,l,c) which can then be used as input data 401 for the machine learning model 109.

FIG. 8 shows an example method that can be used to obtain spatial metadata 115 from the input data 407 by the machine learning model 109 in examples of the disclosure. The example method of FIG. 8 could be performed by the apparatus 101 of FIG. 1 or FIG. 2 or by any other suitable means.

The method receives the input data 407 and the trained machine learning model 109 as inputs. The machine learning model 109 can comprise any suitable model. In some examples the machine learning model 109 can comprise a neural network such as an Open Neural Network Exchange (ONNX) network or any other suitable type of network.

The trained machine learning model 109 can comprise a set of processing weights and processing instructions. The processing weights and instructions can be applied to the input data 407. For instance, where the machine learning model 109 comprises a deep neural network a first set of weights and instructions can be used to process the input data 407. The output of that process is then provided to another layer of the neural network to be processed with a further set of weights of and instructions. This can be repeated as appropriate.

In examples of the disclosure the machine learning model 109 has been trained so that the processing weights are fitted to enable the machine learning model 109 to estimate a corresponding set of reference data based on a determined set of input data 407.

At block 801 the method comprises using the input data 407 and the trained machine learning model to infer output data 803. The inference of the output data 803 uses processing weights that were fitted during the training and the instructions to estimate the output data 803.

The output data 803 can be provided in any suitable format. The format of the output data may be determined by the structure of the machine learning model 109, the format of the input data 407 or any other suitable factor. In this example the output data 803 can be configured to be a data array comprising 24×2 data points. This size of the data array can be used so as to provide 24 frequency bands and two parameters for each frequency band.

The machine learning model 109 is configured to provide output data 803 that indicates a sound direction and a directionality of the sound in frequency bands. In this example the sound direction is an azimuthal direction. The directionality gives an indication of whether the sound is from a point source or comprises ambient sound. The directionality can comprise direction to total energy ratios for the sound in different frequency bands.

The output data 803 might not be in a format that indicates the sound direction and a directionality but could instead be in a format, such as vector values, that relates to them. As an example, the output data 805 can comprise vector values which be denoted as o(k,p), where k=1, . . . , 24 and p=1, 2. the relation between the output data and the sound azimuth direction azi(k) and the ratio ratio(k) is

$$o ( k , 1 ) = cos ( azi ( k ) ) * f ( ratio ( k ) ) \\ o ( k , 2 ) = sin ( azi ( k ) ) * f ( ratio ( k ) ) \\ where \\ f ( ratio ( k ) ) = 1 - \sqrt{1 - {( ratio ( k ) )}^{2}}$$

Therefore, in this example the output data 803 of the machine learning model 109 comprises a vector pointing towards the azimuth direction, where the vector length is a function of an energy ratio parameter.

In this example the energy ratio parameter is not used directly as the vector length. The purpose of using the function ƒ( ) is that large ratios (such as 0.9) can be mapped to smaller values. This means that, during training of the machine learning model 109, a particular difference of the estimated energy ratio causes a larger error at the high ratio range than at the low ratio range. This configuration can be beneficial because human hearing is known to perceive errors at the energy ratio parameter more at the high ratio range when used for spatial audio rendering.

At block 805 the method comprises converting the output data 803 from the machine learning model 109 into spatial metadata 115. This can comprise converting the vector values to direction and energy ratio values. In this example the process comprises converting the output data 803 o(k,p) to direction (azimuth in this example) and ratio values by

$$azi ( k ) = a tan 2 ( o ( k , 2 ) , o ( k , 1 ) ) \\ ratio ( k ) = {f}^{- 1} ( \sqrt{{( o ( k , 1 ) )}^{2} + {( o ( k , 2 ) )}^{2}} )$$

where ƒ⁻¹(α)=\sqrt{1−(1−α)²} is the inverse function corresponding to ƒ( ) described previously. In this example the values are shown to depend on frequency. It is to be appreciated that the values can also be time varying values.

The values azi(k) and ratio(k) provide the spatial metadata 115 as an output of the method.

In this example output data 803 from the machine learning model 109 comprises estimation values o(k,p) where k=1, . . . , 24 is the frequency band and p=1, 2 is the dimension at the horizontal plane. In other examples, the estimation values could comprise more than two dimensions. For instance, if more than two microphone 203 are used to capture the microphone signals 113 and/or if the microphones 203 have directionality then a dimension indicating the elevation or z-axis direction could be used. In such cases, the vector length would be converted to the energy ratio parameter, but it would be possible to determine the direction of the arriving sound so that it includes also the elevation.

It is to be appreciated that various modifications can be made to the examples described herein. For instance, in the examples described above the microphone signals 113 were converted to a delay map 709 and a frequency map 711 comprising normalized inter-microphone correlation values at different delays and frequencies for use as input data 407 for the machine learning model 109. In other examples a normalized complex-valued correlation vector could be formulated for use as the input data 407. This could comprise the same information, or similar information, to the delay map 709 and the frequency map 711 but could be used with different types of machine learning model 109.

In other examples the machine learning model 109 could be configured so that the input data 407 could comprise the microphone signals 113 in the frequency domain. This would be dependent upon the structure of the machine learning model 109.

In some examples the input data 407 that is provided to the machine learning model 109, could also comprise additional information. For instance, in some examples the input data 407 could comprise microphone signal energies. This could be used in cases where the microphones 203 are directional microphones or where the device 201 itself causing shadowing. The shadowing could be in the high frequency range. Such shadowing can provide information related to the sound directions.

In some examples the input data 407 could comprise a plurality inter-microphone correlation pairs. For example, if the capturing device 201 comprised four microphones 203, the delay-frequency correlation maps for each or a part of the microphone pairs could be provided within the input data 407 for the machine learning model 109. In such cases, if some pairs of microphones 203 have elevation differences, then, the machine learning model 109 could estimate the estimation vector values o(k,p) so that they include the third dimension (i.e., p=1, 2, 3). In this case, the estimation values that are output by the machine learning model 109 would describe three dimensional vectors where the vector direction is the direction of arrival with elevation included.

In the above examples the output data 803 of the machine learning model 109 was provided in a form that could be converted to direction and energy ratio values. This can be used in cases where one direction of arrival and an energy ratio value provides a good representation of the perceptual spatial aspects of the spatial sound environment. In other examples it may be beneficial to determine two or more simultaneous direction parameters and corresponding energy ratio values. In such cases the machine learning model 109 can be configured and trained to provide output data 803 comprising a plurality of simultaneous directions and corresponding energy ratios, and/or can be configured and trained to estimate other relevant spatial parameters, such as any spatial coherences at the estimated sound field.

In the examples described above, the input data 407 for the machine learning model 109 was provided in a data array having a form of 64×48×3. In other examples the input data 407 could be in a different form. For example, if the input data 407 comprises a plurality of inter-microphone correlation layer then the input data 407 could be in the form of 64×48×4, where first two layers would contain inter-microphone correlation data from different pairs of microphones 203. The input data 407 could also comprise other measured parameters, such as microphone energies. This additional information could be obtained if the microphones 203 are directional and/or if data from previous frames is used.

Examples of the disclosure therefore enable high quality spatial metadata to be obtained even from sub-optimal or low-quality microphone arrays by using an appropriately trained machine learning model 109 and providing input data 407 in the correct format for the machine learning model 109. The improved the quality of the spatial metadata 115 that can be provided can improves the quality of the spatial audio that is provided using the spatial metadata 115.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. An apparatus, comprising:
at least one processor; and
at least one non-transitory memory storing instructions that, when executed with the at least one processor, cause the apparatus to:
access a trained machine learning model;
determine input data for the machine learning model based on two or more microphone signals;
enable using the machine learning model to process the input data to obtain spatial metadata; and
associate the obtained spatial metadata with at least one signal based on the two or more microphone signals so as to enable processing of the at least one signal based on the obtained spatial metadata.

2. An apparatus as claimed in claim 1, wherein the instructions, when executed with the at least one processor, cause the apparatus to render spatial audio using the at least one signal based on the two or more microphone signals and the obtained spatial metadata.

3. An apparatus as claimed claim 1, wherein the instructions, when executed with the at least one processor, cause the apparatus to at least one of:
obtain cross correlation data from the two or more microphone signals; or
obtain one or more of: delay data or frequency data corresponding to the cross correlation data.

4. (canceled)

5. An apparatus as claimed in claim 1, wherein the instructions, when executed with the at least one processor, cause the apparatus to enable transmission of the two or more microphone signals to one or more processing devices to enable the one or more processing devices to use the machine learning model to obtain the spatial metadata.

6. An apparatus as claimed in claim 5, wherein the instructions, when executed with the at least one processor, cause the apparatus to enable receiving of the obtained spatial metadata from the one or more processing devices.

7. An apparatus as claimed in claim 1, wherein the spatial metadata comprises information relating to one or more spatial properties of spatial sound environments corresponding to the two or more microphone signals, and wherein the instructions, when executed with the at least one processor, cause the apparatus to enable spatial rendering of the at least one signal based on the two or more microphone signals.

8. An apparatus as claimed in claim 1, wherein the spatial metadata comprises, for one or more frequency sub-bands, information indicative of;
a sound direction; and
sound directionality.

9. An apparatus as claimed in claim 1, wherein the instructions, when executed with the at least one processor, obtain the machine learning model from a system configured to train the machine learning model.

10. An apparatus as claimed in claim 1, wherein the instructions, when executed with the at least one processor, cause the apparatus to enable the at least one signal based on the two or more microphone signals and the spatial metadata to be provided to another apparatus to enable rendering of the spatial audio.

11. An apparatus as claimed in claim 1, wherein the machine learning model comprises a neural network.

12-13. (canceled)

14. A method, comprising:
accessing a trained machine learning model;
determining input data for the machine learning model based on two or more microphone signals;
enabling using the machine learning model to process the input data to obtain spatial metadata; and
associating the obtained spatial metadata with at least one signal based on the two or more microphone signals so as to enable processing of the of the at least one signal based on the obtained spatial metadata.

15. A method as claimed in claim 14, wherein the processing comprises rendering of spatial audio using the at least one signal based on the two or more microphone signals and the obtained spatial metadata.

16. A non-transitory program storage device readable with an apparatus, tangibly embodying a program of instructions executable with the apparatus for performing:
accessing a trained machine learning model;
determining input data for the machine learning model based on two or more microphone signals;
enabling using the machine learning model to process the input data to obtain spatial metadata; and
associating the obtained spatial metadata with at least one signal based on the two or more microphone signals so as to enable processing of the at least one signal based on the obtained spatial metadata.

17-20. (canceled)

21. A method as claimed in claim 14, wherein determining input data for the machine learning model comprises at least one of:
obtaining cross correlation data from the two or more microphone signals; or
obtaining one or more of: delay data or frequency data corresponding to the cross correlation data.

22. A method as claimed in claim 14, further comprising at least one of:
enabling transmission of the two or more microphone signals to one or more processing devices to enable the one or more processing devices to use the machine learning model to obtain the spatial metadata; or
enabling receiving of the obtained spatial metadata from the one or more processing devices.

23. A method as claimed in claim 14, wherein the spatial metadata comprises information relating to one or more spatial properties of spatial sound environments corresponding to the two or more microphone signals wherein the information is configured to enable spatial rendering of the at least one signal based on the two or more microphone signals.

24. A method as claimed in claim 14, wherein the spatial metadata comprises, for one or more frequency sub-bands, information indicative of:
a sound direction; and
sound directionality.

25. A method as claimed in claim 14, wherein the machine learning model is obtained from a system configured to train the machine learning model.

26. A method as claimed in claim 14, further comprising enabling the at least one signal based on the two or more microphone signals and the spatial metadata to be provided to another apparatus to enable rendering of the spatial audio.

27. A method as claimed in claim 14, wherein the machine learning model comprises a neural network.
